(19) United States
(12) Patent Application Publication
(10) Pub. No.: US 2026/0349734 A1
(43) Pub. Date: Nov. 5, 2026

(54) TRIGGERING EXECUTION OF AN ALERNATIVE FUNCTION

(71) Applicants: Mbou Eyole, Soham (GB); Andreas Lars Sandberg, Cambridge (GB); Richard Roy Grisenthwaite, Cambridge (GB); Robert Gwilym Dimond, Cambridge (GB)

(72) Inventors: Mbou Eyole, Soham (GB); Andreas Lars Sandberg, Cambridge (GB); Richard Roy Grisenthwaite, Cambridge (GB); Robert Gwilym Dimond, Cambridge (GB)

(73) Assignee: Arm Limited, Cambridge (GB)

(21) Appl. No.: 19/488,964

(22) PCT Filed: Feb. 7, 2024
(86) PCT No.: PCT/GB2024/050329

§ 371 Date: Dec. 1, 2025

(30) Foreign Application Priority Data
Jun. 5, 2023 (GB) 2308374.4

(51) Int. Cl. G06F 9/30

(52) U.S. Cl. CPC G06F 9/3009; G06F 9/30101

(57) ABSTRACT

An apparatus (10, 30, 50) comprising processing circuitry (51) to execute instructions, and threadlet execution circuitry (23, 49, 52) to execute tasks under control of the processing circuitry. The threadlet execution circuitry is configured to operate asynchronously with respect to the processing circuitry. The threadlet execution circuitry is responsive to a start command issued by the processing circuitry to begin execution of a threadlet comprising at least one delegated task. The processing circuitry is responsive to a threadlet-start instruction, the threadlet-start instruction indicating a request to issue the start command to the threadlet execution circuitry, to determine, in dependence on at least one parameter, whether to trigger execution, by the processing circuitry, of an alternative function instead of issuing the start command to the threadlet execution circuitry.

The present technique relates to the field of data processing.

In a data processing system, processing circuitry may be configured to execute a variety of different types of instructions. However, it has been observed that using custom or specialised hardware to execute certain processing tasks can be more efficient that using the processing circuitry to execute those tasks. For example, processing circuitry may pass certain types of processing tasks to a dedicated accelerator, which may be capable of executing those tasks more efficiently and/or more quickly.

However, adding specialised circuitry such as an accelerator increases the hardware cost to implement the data processing apparatus, which can be difficult to justify in some situations due to the pressure for silicon area on a chip. Moreover, an accelerator can significantly increase the complexity of the apparatus, and may consume a significant amount of power.

Viewed from a first example of the present technique, there is provided an apparatus comprising:
processing circuitry to execute instructions; and
threadlet execution circuitry to execute tasks under control of the processing circuitry, wherein the threadlet execution circuitry is configured to operate asynchronously with respect to the processing circuitry;
wherein:
the threadlet execution circuitry is responsive to a start command issued by the processing circuitry to begin execution of a threadlet comprising at least one delegated task; and
the processing circuitry is responsive to a threadlet-start instruction, the threadlet-start instruction indicating a request to issue the start command to the threadlet execution circuitry, to determine, in dependence on at least one parameter, whether to trigger execution, by the processing circuitry, of an alternative function instead of issuing the start command to the threadlet execution circuitry.

Viewed from another example of the present technique, there is provided a computer program comprising computer-readable code for fabrication of the apparatus described above. The computer program may, in some examples, be stored on a computer-readable medium which could be transitory or non-transitory.

Viewed from another example of the present technique, there is provided a method for controlling threadlet execution circuitry to execute tasks, the method comprising:
controlling, using processing circuitry, threadlet execution circuitry to execute tasks, wherein the threadlet execution circuitry is configured to operate asynchronously with respect to the processing circuitry;
issuing, using the processing circuitry, a start command to the threadlet execution circuitry to cause the threadlet execution circuitry to begin execution of a threadlet comprising at least one delegated task; and
in response to a threadlet-start instruction, the threadlet-start instruction indicating a request to issue the start command to the threadlet execution circuitry, using the processing circuitry to determine, in dependence on at least one parameter, whether to trigger execution, by the processing circuitry, of an alternative function instead of issuing the start command to the threadlet execution circuitry.

Viewed from another example of the present technique, there is provided a computer program comprising instructions which, when executed by a host data processing apparatus, control the host data processing apparatus to provide an instruction execution environment for executing target program code, the computer program comprising:
processing program logic to execute instructions; and
threadlet execution program logic to execute tasks under control of the processing program logic, wherein the threadlet execution program logic is configured to operate asynchronously with respect to the processing program logic;
wherein:
the threadlet execution program logic is responsive to a start command issued by the processing program logic to begin execution of a threadlet comprising at least one delegated task; and
the processing program logic is responsive to a threadlet-start instruction, the threadlet-start instruction indicating a request to issue the start command to the threadlet execution program logic, to determine, in dependence on at least one parameter, whether to trigger execution, by the processing program logic, of an alternative function instead of issuing the start command to the threadlet execution program logic.

The computer program may, in some examples, be stored on a computer-readable medium which could be transitory or non-transitory.

Further aspects, features and advantages of the present technique will be apparent from the following description of examples, which is to be read in conjunction with the accompanying drawings, in which:

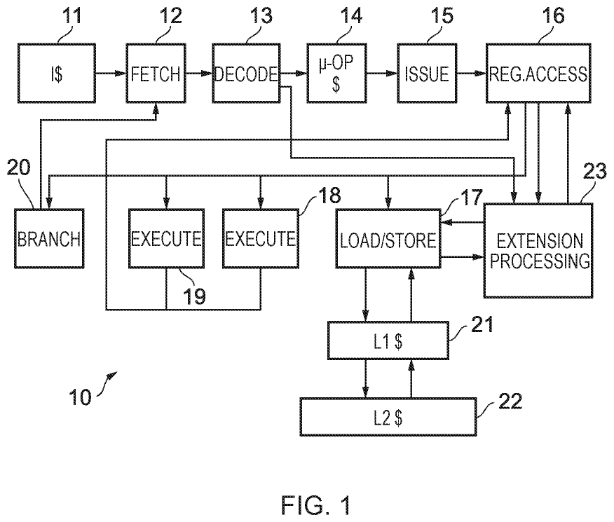

FIG. 1 schematically illustrates a data processing apparatus which may embody various examples of the present techniques;

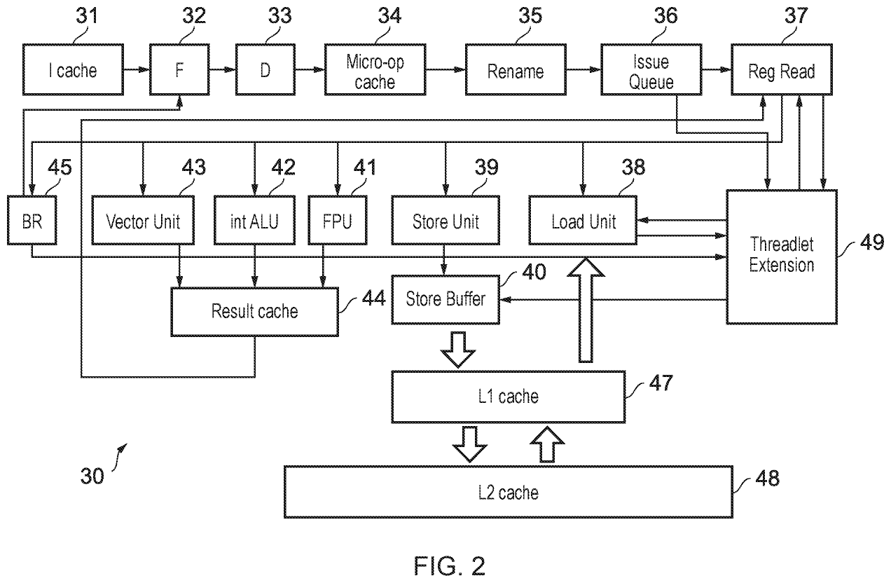

FIG. 2 schematically illustrates a data processing apparatus which may embody various examples of the present techniques;

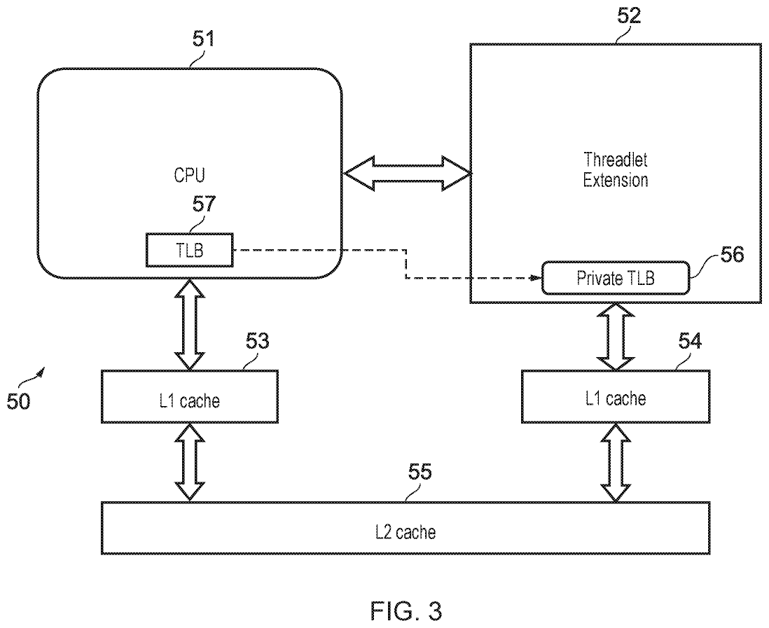

FIG. 3 schematically illustrates a data processing apparatus which may embody various examples of the present techniques;

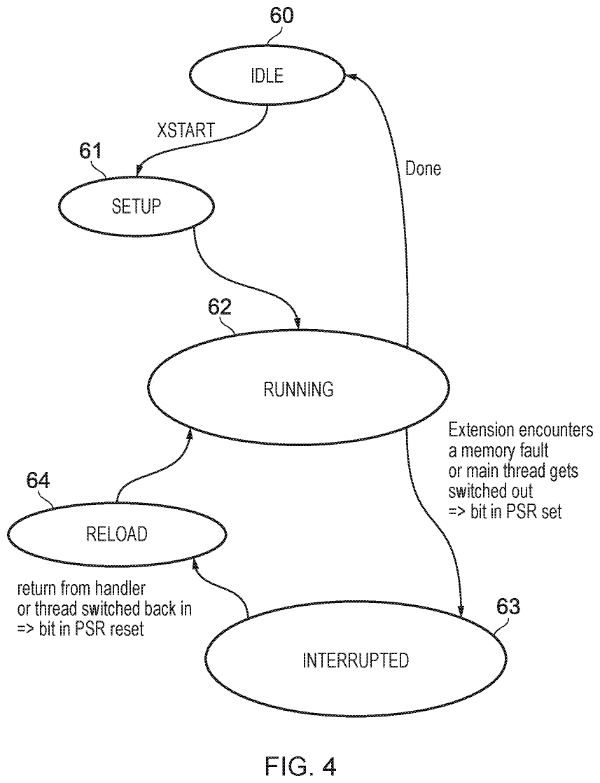

FIG. 4 is a state diagram illustrating an example set of states between which extension processing circuitry of the present techniques may transition;

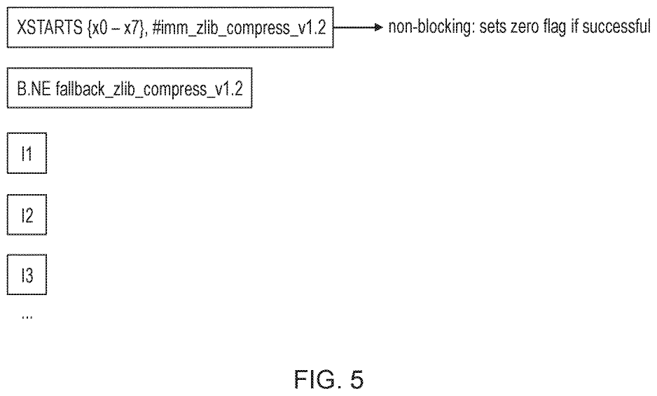

FIG. 5 illustrates an example of a sequence of code which may be executed in accordance with examples of the present techniques;

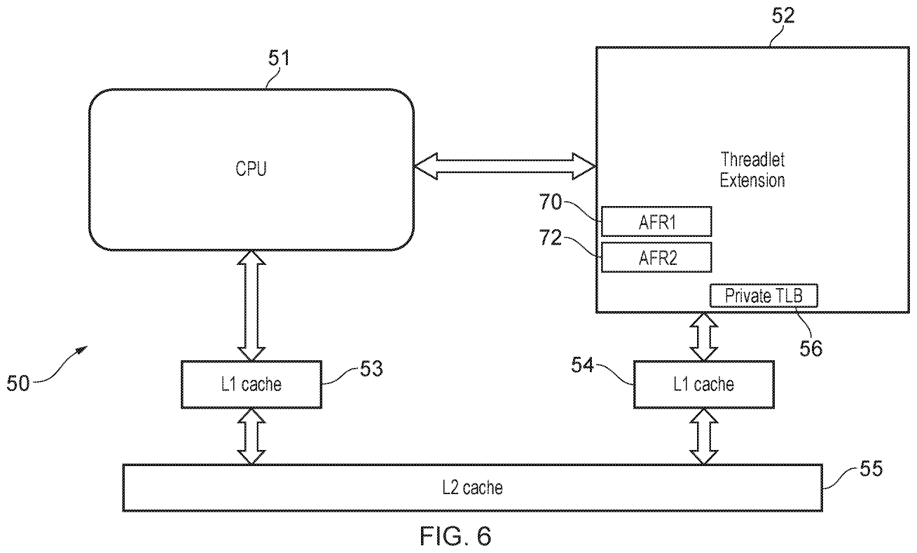

FIG. 6 schematically illustrates a data processing apparatus which may embody various examples of the present techniques;

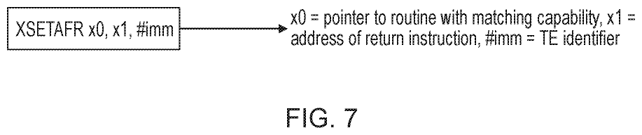

FIG. 7 illustrates an example of a set-AFR instruction;

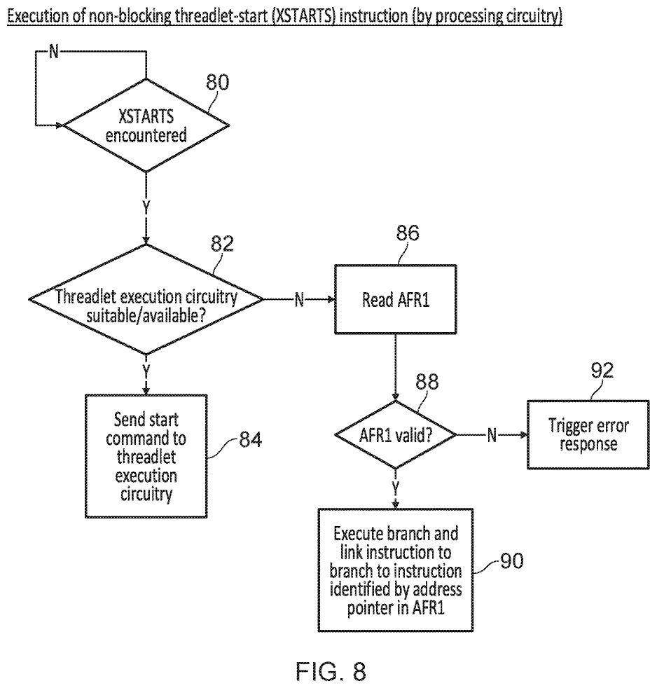

FIG. 8 is a flow diagram illustrating an example method of executing a non-blocking threadlet-start instruction;

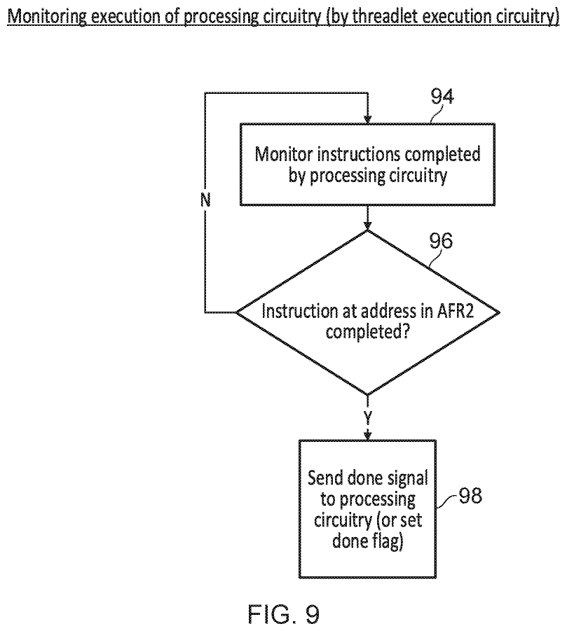

FIG. 9 is a flow diagram illustrating an example method of monitoring execution of instructions by processing circuitry;

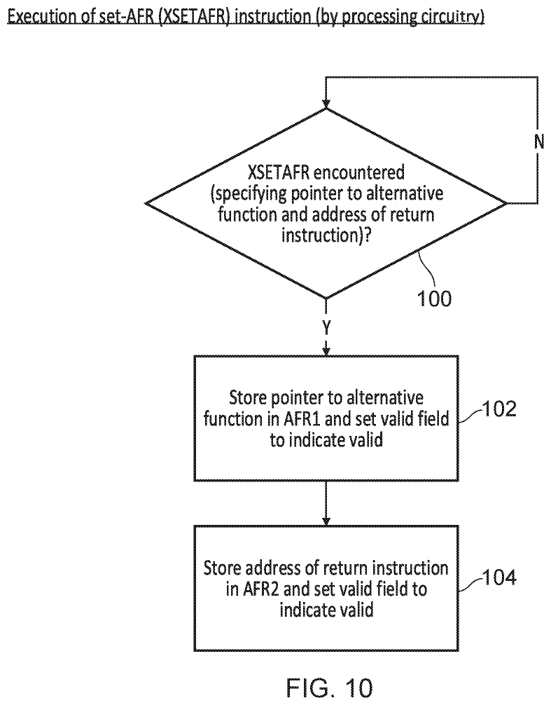

FIG. 10 is a flow diagram illustrating an example method of executing a set-AFR instruction; and

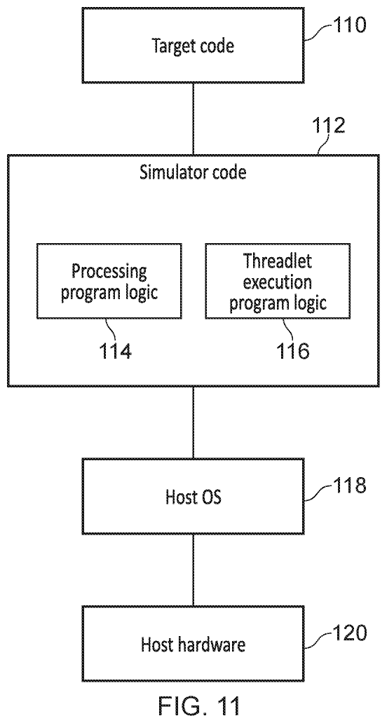

FIG. 11 schematically illustrates a simulator implementation that may be used.

Before discussing example implementations with reference to the accompanying figures, the following description of example implementations and associated advantages is provided.

Examples of the present technique make use of threadlet execution circuitry, provided in addition to processing circuitry, which can execute certain tasks (e.g. containing data processing operations) under the control of the processing circuitry. The threadlet execution circuitry operates asynchronously with respect to the processing circuitry—for example, the threadlet execution circuitry does not operate in lockstep with the processing circuitry, meaning that the processing circuitry can continue to execute instructions alongside the operation of the threadlet execution circuitry.

The processing circuitry controls the operation of the threadlet execution circuitry to the extent that it can issue a start command to the threadlet execution circuitry to cause the threadlet execution circuitry to begin execution of a threadlet comprising one or more at least one delegated task (e.g. delegated by the processing circuitry). In particular, the processing circuitry is capable of executing a threadlet-start instruction (also referred to herein as an “XSTART” or “XSTARTS” instruction) to send the start command to the threadlet execution circuitry.

The present technique also considers what will happen in situations where the threadlet execution circuitry is unavailable at the time a start command is issued. In particular, the inventors of the present technique considered the challenge of ensuring that software encounters no friction in such scenarios where threadlet usage is desirable but no guarantee can be provided that the threadlet execution circuitry will be permanently available.

To address this challenge, the present technique implements a form of the threadlet-start instruction which can trigger execution, by the processing circuitry, of an alternative function (e.g. a function whose execution will provide equivalent (or at least similar) results to execution of the threadlet by the threadlet execution circuitry) when the threadlet execution circuitry is determined to be unavailable and/or unsuitable for execution of the threadlet. In particular, the processing circuitry of the present technique is responsive to a threadlet-start instruction, the threadlet-start instruction indicating a request to issue the start command to the threadlet execution circuitry, to determine, in dependence on at least one parameter, whether to trigger execution, by the processing circuitry, of an alternative function instead of issuing the start command to the threadlet execution circuitry.

In this way, the alternative function provides a fallback path that the processing circuitry can follow if it is not possible or appropriate to send a start command to the threadlet execution circuitry. This avoids the need for the processing circuitry to stall execution or trigger an error response when the threadlet execution circuitry is unavailable and/or unsuitable, and alleviates software friction in such scenarios.

In some examples, the processing circuitry is responsive to determining to trigger execution of the alternative function instead of issuing the start command to the threadlet execution circuitry to branch execution to an identified instruction.

For example the identified instruction can be set such that it identifies the start of the alternative function described above. Hence, this example allows execution to branch to the alternative function if execution by the threadlet execution circuitry is not appropriate for a given threadlet. The branch may, in some examples, be triggered by a branch instruction following the threadlet-start instruction. The branch instruction could, for example, be inserted into the machine code by a compiler, in response to detecting the presence of the threadlet-start instruction. The branch instruction could, in particular examples, be a branch-with-link instruction, in response to which a return address is stored (e.g. in a register such as a link register) so that execution can return to a point just after the threadlet-start instruction once execution of the alternative function is complete.

There are many ways that the identified instruction may be identified. For example, the identified instruction could be identified directly in the threadlet-start instruction (e.g. recording, in a field of the branch instruction or the threadlet-start instruction, an offset of the first instruction in the alternative function).

However, in some examples, there is provided an alternative-function register (AFR), wherein the processing circuitry is responsive to determining to trigger execution of the alternative function instead of issuing the start command to the threadlet execution circuitry to branch execution to an instruction identified by an address indicated in the AFR.

The AFR (also referred to herein as an AFR1 register) can take several forms. In some examples, the AFR comprises one of a general-purpose register associated with the processing circuitry, or a special-purpose register associated with the threadlet execution circuitry.

For example, the AFR may be one of the general-purpose registers in the processing circuitry's register file, and this register may be identified by the threadlet start (XSTARTS) instruction. For example, the threadlet start instruction could take the form:
XSTARTS <other arguments>, x4

where x4 is a general-purpose register in the register file.

Alternatively, the general-purpose register could be identified in a branch instruction following the threadlet start instruction. For example, the branch instruction may immediately follow the threadlet-start instruction, with the two instructions being merged or fused in the frontend, and the branch instruction being edited to identify the register.

Alternatively, a dedicated AFR could be provided in association with the threadlet-execution circuitry. In this case, the AFR need not necessarily be identified in the threadlet-start instruction, because it may be implicit that execution is to branch to the address stored in the AFR as the fallback option. Note that there may be more than one AFR provided in association with the threadlet execution circuitry—for example, there may be an AFR provided for each function that is supported by the threadlet-execution circuitry. In such cases, it may be beneficial to identify the AFR in the threadlet-start instruction. In this example, the AFR provides dedicated hardware support for the present technique, by providing a dedicated storage location for information identifying the alternative function.

In some examples, the processing circuitry is responsive to a set-AFR instruction to store, in the AFR, an address pointer specified by the set-AFR instruction.

According to this example, architectural support is provided for a new instruction—the set-AFR instruction. The set-AFR instruction can be used to set up the AFR to identify the alternative routine to be used when the threadlet-execution circuitry is unavailable or unsuitable, avoiding the need to set a specific branch target for the threadlet-start instruction, which saves encoding space in the threadlet-start instruction.

In some examples, the processing circuitry is responsive to the set-AFR instruction to record a predetermined value in a valid field of the AFR, the predetermined value indicating that the AFR holds an indication of a valid address.

In this example, the set-AFR instruction is further configured to trigger the setting of a “valid” field in the AFR. This indicates whether the AFR indicates a valid address value, thus reducing the risk of execution branching to an unsafe or otherwise incorrect location.

In some examples, the processing circuitry is responsive to determining to trigger execution of the alternative function instead of issuing the start command to the threadlet execution circuitry to determine whether a valid field of the AFR holds a predetermined value indicating that the AFR holds a valid indication of an address, and in response to determining an absence of the predetermined value in the valid field of the AFR, initiate an error response.

Hence, in this example, the processing circuitry only branches to the location identified in the AFR if the valid field (e.g. this could be a single bit) is set to indicate that the address information stored therein is valid. This prevents the code from branching to an incorrect location.

There are many possible reasons that the threadlet execution circuitry may be either unavailable or unsuitable for execution of a given threadlet, and the at least one parameter described above can be set in any of a number of ways corresponding to these reasons.

In some examples, the processing circuitry is configured to determine whether to trigger execution of the alternative function instead of issuing the start command to the threadlet execution circuitry in dependence on, as the at least one parameter, whether the execution, by the threadlet execution circuitry, of a previous threadlet is in progress.

For example, the threadlet execution circuitry may only be capable of executing a given number of threadlets at once (e.g., the threadlet execution circuitry may only be capable of executing a single threadlet at a time), in which case it may not be possible for the threadlet execution circuitry to begin executing a new threadlet while it is still executing a previous threadlet. Hence, it can be useful to set the at least one parameter in dependence on whether execution of a previous threadlet is still in progress.

In some examples, the processing circuitry is responsive to determining that execution, by the threadlet execution circuitry, of the previous threadlet is in progress to trigger execution of the alternative function instead of issuing the start command to the threadlet execution circuitry.

Hence, setting the at least one parameter in dependence on whether a previous threadlet is executing allows the processing circuitry to trigger execution of the alternative function when the threadlet execution circuitry is unavailable for this reason.

In some examples, the threadlet execution circuitry is configured to set a cessation indication in response to completion of execution of the previous threadlet, and the processing circuitry is configured to determine whether the threadlet execution circuitry has completed execution of the previous threadlet in dependence on whether the cessation indication has been set.

For example, the cessation indication could be a signal that is asserted by the threadlet execution circuitry upon completion of execution of a threadlet, or it could be a flag set (e.g. in a control register or other storage location) by the threadlet execution circuitry upon completion of execution of the threadlet. The at least one parameter may then be set in dependence on whether the cessation indication has been set, allowing the processing circuitry to determine whether execution of the previous threadlet has completed.

In some examples, the processing circuitry is configured to determine whether to trigger execution of the alternative function instead of issuing the start command to the threadlet execution circuitry in dependence on, as the at least one parameter, one or more power and/or thermal requirements.

Another reason to execute the alternative function instead of issuing the start command to the threadlet execution circuitry could be that use of the threadlet execution circuitry may be constrained or forbidden by current power and/or thermal requirements set for the apparatus. For example, because the threadlet execution circuitry runs alongside the processing circuitry (e.g. the threadlet execution circuitry and the processing circuitry are asynchronous), this can mean that it is likely that the overall power consumption will increase if a processing task is offloaded to the threadlet execution circuitry, at least while the threadlet is being executed. This, in turn, may increase the amount of heat generated by the apparatus during that time. Therefore, it may be that a current power and/or thermal profile set for the apparatus (which may set limits on the power consumption and/or heat production permitted for the apparatus during a given period of time) constrains or does not permit the use of the threadlet execution circuitry. Hence, in these cases, the processing circuitry may determine not to issue the start command, even if the threadlet execution circuitry is currently available and suitable for execution of the threadlet.

Thus, the ability to instead branch to an alternative function can allow processing to continue, while still satisfying the power and thermal requirements for the system.

In some examples, the processing circuitry is configured to determine whether to trigger execution of the alternative function instead of issuing the start command to the threadlet execution circuitry in dependence on, as the at least one parameter, whether the at least one delegated task are supported by the threadlet execution circuitry.

The threadlet execution circuitry may only support certain types of task. In this example, the processing circuitry can be configured to, if a threadlet comprises a task involving data processing operations which are not supported by the threadlet execution circuitry, determine to trigger execution of the alternative function instead of issuing the start command. In this way, it is not necessary for a programmer to have knowledge of which tasks are supported by the threadlet execution circuitry at the time of generating code, and the processing circuitry need not stall or trigger an error response if a threadlet-start instruction is executed which relates to a threadlet comprising a task which is not supported by the threadlet execution circuitry.

In some examples, the processing circuitry is configured to determine whether to trigger execution of the alternative function instead of issuing the start command to the threadlet execution circuitry in dependence on, as the at least one parameter, a determination of whether a granularity of the threadlet satisfies a threshold granularity defined for the threadlet execution circuitry.

Granularity relates to the size or magnitude of a task delegated to threadlet execution circuitry. In some instances this is synonymous with the “time” it takes to execute the task, as measured by number of clock cycles, for example. Fine-grained in this context means each offloaded task takes only a small number of cycles (e.g. hundreds, whereas a larger granularity might imply thousands or more).

There is a relationship between granularity and speculation (e.g. from the CPU's perspective)—for example, if a relatively costly overhead such as a speculation barrier or a miss-speculation is encountered, and the granularity of the threadlet is low, then those overheads can outweigh any benefits of delegating a task to the threadlet execution circuitry. In addition, if the threadlet execution circuitry lacks significant speculation depth, then this can lead to stalls which are detrimental to efficiency.

These overheads can vary at runtime, so, in some embodiments there could be a mechanism to determine whether it is profitable to launch the threadlet or not. Therefore, in this example of the present technique, the processing circuitry may decide to trigger execution of the alternative function instead of launching the threadlet in some cases based on the assessment of profitability/cost.

In some examples, the threadlet execution circuitry is responsive to completion of execution of the alternative function to set a cessation indication.

This can be advantageous, because it allows the processing circuitry to then respond as if the threadlet execution circuitry had just completed execution of the threadlet. Depending on the content of the alterative function, this can help to ensure that the result of the execution of the alternative function appears, to software, to be functionally identical to execution of the threadlet. In a particular example, the threadlet execution circuitry may have a dedicated set of registers to store operands and results for data processing operations performed as part of the delegated task. This may be set up by a start command, which the cessation indication may trigger the threadlet execution circuitry to buffer the contents of its registers (e.g. the results of the data processing operations) to be presented to the data processing circuitry.

In some examples, the apparatus comprises an alternative-function-return register to hold an indication of a return instruction address, wherein the threadlet execution circuitry is configured to monitor execution of instructions by the processing circuitry and determine, based on the return instruction address, whether the processing circuitry has executed a corresponding return instruction, and the threadlet execution circuitry is responsive to determining that the processing circuitry has executed the corresponding return instruction to set the cessation indication.

Typically, a function may end with a return instruction, which indicates that processing is to return to a particular point. For example, a return address may be indicated in a register (e.g. a link register) indicating the point to which processing is to return once execution of the function has completed—execution of the return instruction may, therefore, trigger execution of an instruction identified by the return address. For example, a return address may be stored in the link register in response to execution of a “branch with link” instruction. In this example, the threadlet execution circuitry uses execution of the return instruction to determine when execution of the alternative function has completed, and hence when to set the cessation indication. In order to enable to threadlet execution circuitry to identify that the return instruction has been executed, the apparatus of this example comprises an alternative-function-return register hold an indication of an address corresponding to the return address of the function. The threadlet execution circuitry can then monitor the operation of the processing circuitry, to compare the addresses of committed instructions with the address stored in the alternative-function-return register. This allows the threadlet execution circuitry to observe when execution of the alternative function has completed, and to set the cessation indication once this is observed to have taken place.

In some examples, the apparatus comprises an alternative-function register (AFR), wherein the processing circuitry is responsive to determining to trigger execution of the alternative function instead of issuing the start command to the threadlet execution circuitry to branch execution to an instruction identified by an address indicated in the AFR, and the processing circuitry is responsive to a set-AFR instruction to store, in the AFR, an address pointer specified by the set-AFR instruction, and store, in the alternative-function-return register, a return instruction address pointer specified by the set-AFR instruction.

Hence, in this example, the set-AFR instruction described above is usable to set up both the AFR and the alternative-function-return register.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may be define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may embody computer-readable representations of one or more netlists. The one or more netlists may be generated by applying one or more logic synthesis processes to an RTL representation. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

The techniques discussed above can be implemented in a hardware apparatus which has circuit hardware implementing the processing circuitry, the threadlet execution circuitry and, optionally, the other hardware features described above (e.g. the alternative function register (AFR) and the alternative-function-return register), which support the threadlet start instruction (and, optionally, the set-AFR instruction) as part of the native instruction set architecture supported by the decode circuitry and processing circuitry.

However, in another example the same techniques may be implemented in a computer program (e.g. an architecture simulator or model) which may be provided for controlling a host data processing apparatus to provide an instruction execution environment for execution of instructions from target code. The computer program may include processing program logic to emulate the processing circuitry described above, and threadlet execution program logic to emulate the threadlet execution circuitry described above. The processing program logic includes support for the threadlet-start instruction which has the same functionality as described above for the hardware example. Hence, such a simulator computer program may present, to target code executing on the simulator computer program, a similar instruction execution environment to that which would be provided by an actual hardware apparatus capable of directly executing the target instruction set, even though there may not be any actual hardware providing these features in the host computer which is executing the simulator program. This can be useful for executing code written for one instruction set architecture on a host platform which does not actually support that architecture. Also, the simulator can be useful during development of software for a new version of an instruction set architecture while software development is being performed in parallel with development of hardware devices supporting the new architecture. This can allow software to be developed and tested on the simulator so that software development can start before the hardware devices supporting the new architecture are available.

In some examples, the program may also include instruction decoding program logic for decoding instructions of the target code so as to control a host data processing apparatus to perform data processing. Hence, the instruction decoding program logic emulates the functionality of an instruction decoder of a hardware apparatus as discussed above. The instruction decoding program logic may include support for the threadlet-start instruction and, optionally, the set-AFR instruction described above. Other instructions described herein may also be supported by the instruction decoding program logic and the processing program logic. Also, in some examples, the program may include register maintenance program logic which maintains a data structure (within the memory or architectural registers of the host apparatus) which represents (emulates) the architectural registers of the instruction set architecture being simulated by the program. The emulated registers may include any of the registers described in some examples above, including the alternative function register (AFR) and the alternative-function-return register described above.

The simulator code described herein may be stored on a computer-readable medium, which may be transitory or non-transitory.

Particular embodiments will now be described with reference to the figures.

FIG. 1 schematically illustrates a data processing apparatus 10 according to some examples. The data processing apparatus 10 is schematically shown to have a pipelined configuration, which for the purposes of brevity and clarity is shown in a conceptual representation here. The illustrated pipeline stages comprise an instruction cache 11, a fetch stage 12, a decode stage 13, a micro-op cache 14, an issue stage 15, and a register access stage 16. A sequence of instructions is retrieved from memory (not shown) and cached in the instruction cache 11. The fetch stage 12 controls which instructions are retrieved as the sequence of instructions and these instructions are then decoded in the decode stage 13. This decoding essentially identifies the type of each instruction, as well as any further operands specified by the instruction, and generates control signals to control the remainder of the apparatus to perform the data processing operation(s) defined by the instruction. Decoding the instructions may comprise splitting an instruction into one or more micro-ops, and these micro-ops can be cached in the micro-op cache 14. The final stage of the pipeline before execution is the issue stage 15, where instructions (or micro-ops) are queued pending the availability of the register values they specify as operands and the corresponding functional unit of the data processing pipeline which will carry out the defined operation. Generally the data processing operation(s) defined by the instructions are carried out by the functional units that form part of the data processing pipeline, namely the load/store unit 17, the execute unit 18, and the execute unit 19. These latter execute units may for example be arithmetic logic units (ALUs), floating point units (FPUs), and so on. The functional units that form part of the data processing pipeline perform their data processing operations on data values which are provided from a set of registers (conceptually represented by the register access stage 16 in the figure) and result values of those data processing operations are returned to the set of registers. The load/store unit 17 is provided for the purpose of storing values from the set of registers to the memory system, of which only a level 1 cache 21 and a level 2 cache 22 are shown in the figure. The L1 cache 21 is private to the data processing apparatus 10 and the L2 cache 22 may be shared with another data processing apparatus, when part of a wider data processing system. The data processing apparatus 10 is also shown to comprise a branch unit 20, which monitors execution flow of the sequence of instructions and seeks to predict, based on previous execution history, whether a given branch will be taken or not. The predictions from the branch unit 20 inform the sequence of instructions caused to be fetched by the fetch stage 12.

The data processing apparatus 10 further comprises extension processing circuitry 23, which is provided to support efficient performance of one or more defined functions, which have been established to be impactful and ubiquitous for the data processing operations which this data processing apparatus 10 carries out. “Extension processing circuitry” is another name for “threadlet execution circuitry”. Example functions of this type have been found to include tasks or functions such as memcpy, memset, compression, encryption, and string processing, although the present techniques are not limited to these particular examples. The extension processing circuitry is closely associated with the data processing pipeline and is configured to perform the defined function (also referred to herein as a delegated task) in response to a delegation signal received from the data processing pipeline. The “delegation signal” is another name for the “start signal” described above. The extension processing circuitry 23 is an example of a threadlet extension (TE) according to the present techniques. The sequence of operations it carries out to perform the defined function is referred to as a threadlet herein. The extension processing circuitry 23, although closely associated with the data processing pipeline, is configured to perform the delegated task asynchronously to the data processing operations performed by data processing pipeline. The data processing pipeline may also be referred to as the CPU herein. Threadlets are functions or collections of operations that can be executed asynchronously relative to other CPU activity once launched. The directive or command sent to the extension processing circuitry 23 to initiate the delegated task is generated in response to an extension start instruction (also referred to herein as a threadlet-start instruction) defined for this purpose in the instruction set of the data processing pipeline. Thus, an extension start instruction progresses along the data processing pipeline in the manner that any other CPU instruction would, but when the decoding circuitry 13 identifies the extension start instruction it can signal directly to the extension processing circuitry 23. The close integration of the extension processing circuitry 23 with data processing pipeline is illustrated by the fact that the extension processing circuitry 23 has direct access to the load/store unit 17, and thus it shares the data processing pipeline's path to memory. The extension processing circuitry 23 also has access to the set of registers 16, such that for example, the extension start instruction can specify one or more registers as operands, and the values from these registers are then passed directly to the extension processing circuitry 23 in association with the command sent to initiate the delegated task. Upon completion of the task, results of the delegated task can be returned to the register values via an extension synchronisation instruction.

FIG. 2 schematically illustrates a data processing apparatus 30 according to some examples. It will be noted that the arrangement of components of the data processing apparatus 30 is similar to that of the components of the data processing apparatus 10 shown in FIG. 1. One difference is that whilst the data processing apparatus 10 of FIG. 1 is intended to represent an in-order processor, the data processing apparatus 30 is an out-of-order processor. As one consequence of this the data processing pipeline of the data processing apparatus 30 comprises a rename stage 35, allowing the data processing apparatus 30 to vary the order in which it executes instructions of the sequence of instructions, such that they can be executed in an order dictated by when their operands become available, and the availability of functional units, rather than the order in which they appear in the sequence. The illustrated pipeline stages comprise an instruction cache 31, a fetch stage 32, a decode stage 33, a micro-op cache 34, the rename stage 35, an issue stage 36, and a register access stage 37. A sequence of instructions is retrieved from memory (not shown) and cached in the instruction cache 31. Instructions pass through the data processing pipeline in the manner described above with reference to the data processing apparatus 10 of FIG. 1, with the further register renaming that is performed by the rename stage 35. The functional units of the data processing pipeline in this example are the load unit 38, the store unit 39, the FPU 41, the integer ALU 42, and the vector unit 43. The throughput of the FPU 41, the integer ALU 42, and the vector unit 43 is sufficient that a result cache 44 is provided as an intermediary before results of their data processing are returned to the registers 37. A branch prediction unit 45 is also provided and its predictions inform the operation of the fetch stage 32.

The data processing apparatus 30 further comprises extension processing circuitry (“threadlet extension” or “threadlet execution circuitry”) 49, which is provided to support efficient performance of one or more defined functions, which have been established to be impactful and ubiquitous for the data processing operations which this data processing apparatus 30 carries out. The extension processing circuitry 49 is closely associated with the data processing pipeline and is configured to perform the defined function in response to a delegation signal (“start signal”) received from the data processing pipeline. In the example of FIG. 2, this delegation signal is shown emanating from the issue queue stage 36. Notably, this is after the rename stage 35, such that the extension processing circuitry 49 can operate with respect to the physical registers of the set of registers 37 according to the same mapping of architectural registers used for the rest of the apparatus. As in the example of FIG. 1, the data processing pipeline (instruction cache 31 through to the register read stage 37, the load/store units 38 and 39, and the functional units 41-45) may also be referred to as the CPU. The threadlet extension 49 operates asynchronously relative to other CPU activity once launched. The directive or command sent to the extension processing circuitry 49 to initiate the delegated task is generated in response to an extension start instruction defined for this purpose in the instruction set of the data processing pipeline. The close integration of the extension processing circuitry 49 with data processing pipeline is also apparent in this example by the fact that the extension processing circuitry 49 has direct access to the load unit 38 and the store buffer 40, and thus it shares the data processing pipeline's path to memory. The extension processing circuitry 49 also has access to the set of registers 37, such that for example, the extension start instruction can specify one or more registers as operands, and the values from these registers are then passed directly to the extension processing circuitry 49 in association with the command sent to initiate the delegated task. Note that the output of the branch prediction unit 45 is also provided to the extension processing circuitry 49. Upon completion of the task, results of the delegated task can be returned to the register values via an extension synchronisation instruction.

FIG. 3 schematically illustrates a data processing apparatus 50 according to some examples. This example provides a comparison to the examples of FIG. 1 and FIG. 2, in which examples the extension processing circuitry was closely embedded with the data processing pipeline, to the extent that those instances of extension processing circuitry may be considered to be within the CPU. In the example apparatus 50 of FIG. 3, the CPU 51 and the extension processing circuitry (threadlet extension) 52 are not as closely integrated. For example this is illustrated by the fact that each has its own path to memory, with an L1 cache 53 private to the CPU 51 and an L1 cache 54 private to the threadlet extension 52. They share the L2 cache 55. Nevertheless, the threadlet extension 52 remains tightly coupled to the CPU 51, and can be launched quickly when an extension start instruction is encountered in the CPU pipeline specifying the function this threadlet extension 52 performs. The threadlet extension 52 can get data directly from CPU registers at the start of its execution. Upon completion, it can return values via an extension synchronisation instruction. FIG. 3 also shows the threadlet extension 52 as having its own private TLB 56, in which it can cache currently used address translations. As a preparatory step before or associated with the delegation signal, content from the TLB 57 in the CPU 51 can be copied into the private TLB 56 in order to pre-warm this cache before the threadlet begins operation.

FIG. 4 is a state diagram illustrating an example set of states between which an extension processing circuitry (TE) transitions in some examples. Initially the TE is in an IDLE state 60. When an extension start (XSTART) instruction (threadlet-start instruction) is encountered by the data processing pipeline, a delegation signal (start signal) can cause the TE to switch to the SETUP state 61. This may also require a signal indicating that the XSTART instruction has been committed to be asserted. In the SETUP state 61, certain actions necessary for preparing the TE can be performed, for example, in examples in which the TE has a separate path to memory (as in the case of FIG. 3), one setup task is the transfer of relevant entries currently in the CPU's TLB to a private TLB within the TE. This enables the TE to perform translations independently at a faster rate than if it were to rely entirely on the existing translation mechanism within the CPU. If the TE has been in a clock-gated or power-gated condition when in the IDLE state 60, the SETUP state 61 may also comprise the task of exiting the TE from that clock-gated or power-gated condition. Once the SETUP state 61 is complete the TE can switch to the RUNNING state 62. If the TE encounters a memory fault during its processing, it asserts a signal which will raise an interrupt within the CPU, causing it to stop executing the main thread and switch to a handler. The TE switches to the INTERRUPTED state 63. An indication of the source of the fault is placed in a special syndrome system register, the address associated with the fault is stored in the fault address system register, and a bit in the Program Status Register (PSR) will be set enabling the handler to quickly determine the source of the fault. Setting a bit in the PSR makes communicating the resumption of the threadlet straightforward, because the handler can reset the relevant bit in the SPSR and when the CPSR is restored from the SPSR during exception return, the TE can detect the resetting of this bit and resume executing. The TE will also switch to the INTERRUPTED state 63 if the main thread gets switched out, e.g. during a context-switch initiated by the operating system. In the INTERRUPTED state 63, the TE may be clock-gated or power-gated, unless some other thread launches a new command directed at it or the associated thread returns resumes execution or the handler returns. The TE returns from the INTERRUPTED state 63 to the RUNNING state 62 via the RELOAD state 64 in which any context or state relevant to its execution, which was previously saved to memory, can be restored. This might be the case if another thread made use of a TE which was previously interrupted. Finally, when the extension reaches the end of the offloaded granule of computation (the delegated task) it moves to the IDLE state 60. The TE will advertise completion of the task, so that an extension synchronisation instruction (XSYNC) can pick up that “done” signal (also referred to herein as a “cessation” signal or “cessation indication”) and, if required, provide a return value to a specified register. If the TE has any lingering data in its private caches it might also need to flush these entries upon completion.

An example of using threadlets is now set out. The programmer or compiler identifies functions whose execution in custom hardware (extension processing circuitry) satisfies the cost-benefit thresholds in their use-case. An instruction (such as XSTART) is used to launches a command within the designated CPU extension. An example use written in pseudo-code (for such an identified function “funcX”) is as follows:

```
funcA ( ) {
  ...
  XSTART {x0 − x3}, #imm_op //funcX(a, b, c, d);
  I1
  I2
  I3
  I4
  ...
  XSYNC x0, #imm_op
  ...
}
```

Thus, within the function funcA, the XSTART instruction initializes the CPU extension and transfers to the extension processing circuitry the parameters (a, b, c, d) for funcX, which are in registers x0, x1, x2, x3 respectively. The XSTART instruction in this example also specifies the immediate value #imm_op, which defines the specific function to be carried out. For example, whilst there might only be one instance of extension processing circuitry, it may be capable of performing more than one function, or at least more than one variant of a function, and the immediate value #imm_op can select the desired variant and/or function. In other examples there may be more than one instance of extension processing circuitry and the immediate value #imm_op can select between them. Depending on the setup, the extension could also automatically get a copy of relevant entries in the TLB. The extension processing circuitry then carries out the task required (funcX) and during its execution, the CPU is free to carry on executing other instructions I1, I2, I3, I4, etc. At some point in the future, the CPU executes an extension synchronisation instruction (XSYNC) which automatically checks whether the extension has completed or not. If it has not, for some variants of the extension synchronisation instruction, the CPU will wait for the delegated task to complete. Other variants of the extension synchronisation instruction (e.g. the XSYNCS variant) allow the CPU can carry on executing other code (if there are alternative routines available or stop executing and wait for completion of the extension (typically if there is nothing else to execute in the interim).

For example, three potential variants of the XSYNC instruction could be:
1. XSYNC {x0-x7}, #imm
   This instruction checks whether the TE specified by the immediate field (#imm) has completed execution. If it has, the instruction returns the results in the list of registers (x0-x7) specified. This variant of the instruction will not commit if the extension has not completed execution, and will effectively stall until the extension completes and can return results.
2. XSYNCS {x0-x7}, #imm
   This is the non-blocking variant of XSYNC mentioned above, and it sets one or more flag bits allowing subsequent code to continue execution (e.g. to execute some alternative computation whilst it is waiting, perhaps by using a branch instruction that is sensitive to the relevant flag bits).
3. XSYNCS {x1-x8}, x0
   This variant is similar to the other XSYNCS variant, but uses a register (x0) to check completion of a specified TE.

There are also several variants of the XSTART instruction, including:
4. XSTART {x0-x7}, #imm
   Sends a start command and a variable number of registers (x0-x7) to the TE, the registers containing parameters for configuring the TE to execute the threadlet. The immediate field is used to identify which TE to activate (when there are multiple TEs implemented) and which operation to perform (when multiple types of operations are possible). this variant of the instruction will not commit until the extension is able to accept the start command, so it will effectively stall if the execution is already executing a task or is otherwise unavailable.
5. XSTARTS {x0-x7}, #imm
   Similar to XSTART, but non-blocking. This means that, if the TE is unavailable, one or more flag bits will be set to indicate its status and to allow subsequent code to continue execution e.g. to execute an alternative function as discussed above).
6. XSTART x0, {x0-x7}, #imm
   This variation of the XSTART instruction sends a start command to any available TE when there are a plurality of TEs capable of executing the specified command, and returns an identifier of the selected TE in x0 which can later be used for checking completion.

Examples of the present technique also define some additional new instructions, including:
7. XEVENT ×0
   This instruction is useful to mitigate the cost of software polling the state of TEs to determine which one has completed. It returns (via x0 in this case) the ID of a TE that has completed, so that the threadlet model can be more easily incorporated into event-driven software architectures.
8. XSETAFR x0, x1, #imm
   This instruction is used to set up the alternative-function register (AFR1) and the alternative-function-return register (AFR2), as will be described in more detail below.

Thus, examples of the present techniques provide architectural support for one or more new instructions to be added to the instruction set architecture (ISA). Adding instructions to the ISA is non-trivial, given the limited encoding space available within instructions, and so it will be appreciated that it is not always obvious that such new instructions are worth the cost of their implementation. However, the inventors of the present techniques realised that the benefits of providing these instructions may outweigh the associated costs. For example, the XSTART and XSYNC instructions (and their variants) enable the functionality of the threadlet execution circuitry, which can help to improve performance for the reasons set out above. The XEVENT instruction is beneficial because it allows the threadlet model to be more easily incorporated into certain types of architectures. Finally, the XSETAFR instruction is advantageous because it allows the AFR1 and AFR2 registers to be set up (as discussed below), which provide hardware support for the ability to execute an alternative function when the threadlet execution circuitry is unavailable and/or unsuitable.

The threadlet-execution circuitry (or “extension processing circuitry”) discussed above can have several advantages. For example, its use can improve CPU performance and efficiency by creating a new hardware unit that can run asynchronously relative to the rest of the CPU, and become a target for offloading certain critical functions. Examples of the present technique seek to further improve systems implementing threadlet-execution circuitry, and are directed towards addressing challenges such as how to limit the friction experienced by software in scenarios where threadlet usage (e.g. offloading tasks to the threadlet processing circuitry) is desirable, but where no guarantee can be provided that the TE will be permanently available. In other words, the present techniques aim to enable code accessing threadlet functionality to work regardless of whether the TE is available, thus avoiding uncertainty from the programmer's or system developer's perspective.

FIG. 5 shows an example of a code sequence that might typically appear at the launch point of threadlet. As shown in the figure, the sequence includes an XSTARTS instruction which, as discussed above, is a non-blocking version of the threadlet-start instruction which sets a zero flag if its execution is unsuccessful. Next in the sequence is a B.NE (branch if not equal) instruction—note that this example of the present technique is not limited to a B.NE instruction, and other conditions (e.g. other than “not equal”) may alternatively be used. This is an instruction which branches to an identified instruction if a certain condition is not met, the condition depending on whether the TE is available and/or suitable for use for execution of the threadlet. The label “fallback_zlib_compress_v1.2” in this example identifies the fallback routine (alternative function) to be executed when the TE is unavailable. In this particular example, the fallback routine performs zlib compression; however the routine chosen as the fallback routine will vary depending on the task for which use of the TE is being requested. The instruction to which execution branches may be identified in the B.NE instruction or in the XSTARTS instruction (e.g. by identifying a register which stores the address of the instruction), or it might be identified by a dedicated register associated with the TE (that need not necessarily be explicitly identified in either of the instructions). Note that another form of branch instruction (e.g. other than a B.NE instruction) could be used instead. Instructions I1, I2, I3 are shown to represent the rest of the instructions in the sequence, and could be any type of instruction. As noted above, offloading of the threadlet to the TE means that the processing circuitry can continue to execute I1, I2 and I3 alongside the execution of the threadlet by the TE; however, it will be appreciated that if it is decided not to issue the start command, these instructions may not be executed until execution of the alternative function has completed.

There are a number of reasons that the TE might be unavailable at the time of execution of the XSTARTS instruction. For example:
the TE might still be executing a previous threadlet, thus making it unavailable for beginning execution of a further threadlet associated with the XSTARTS instruction;
the current power and/or thermal profile set for the CPU might be such that threadlet execution is not allowed, or is somehow constrained;
the exact operation(s) requested (e.g. the data processing operation(s) contained within the threadlet) may not be supported by the TE—for example, this could be because the operations themselves are not supported (e.g. the threadlet contains a memcpy function, but the TE does not support memcpy functions), or parameters associated with the operations may be unsupported (e.g. requesting a compression level outside what is supported by the TE);
the granularity requested might not satisfy an internal threshold developed from heuristics dependent on a permissible level of speculation for the TE.

Whatever the reason, the processing circuitry (CPU) responds to determining that the TE is unavailable by triggering execution of an alternative function instead of issuing the start command. As mentioned above, the alternative function can be identified in any of a number of ways; however, examples of the present technique introduce a register, associated with the TE, which holds an indication of an address identifying the start of the alternative function.

FIG. 6 shows an example of special-purpose registers which may be provided to enable execution of the alternative function when the TE is unavailable. In this example, the registers are provided within the TE 52; however, in other examples the registers may be separate from (but associated with) the TE.

The registers include an alternative-function register (AFR1—also labelled “AFR” in some examples) 70 and an alternative-function-return register (AFR2) 72. The alternative-function register (AFR1) 70 holds information indicative of an address indicating the start of an alternative function to be executed by the CPU when the threadlet execution circuitry 52 is unavailable. For example, the alternative-function register 70 may hold an address pointer to the first instruction of the alternative function. The alternative-function-return register (AFR2) 72 holds information indicative of an address indicating an end of the alternative function—for example, the alternative-function-return register 72 may hold an address pointer to a return instruction at the end of the alternative function. Multiple copies of each of the AFR1 70 and the AFR2 72 may be provided- or example, a separate pair of an AFR1 and AFR2 may be provided for each of several different types of operation. The AFR1 and AFR2 registers thus provide hardware support for the present technique, by providing designated locations in which to identify an alternative function to be executed when the TE is unavailable.

When the AFR1 register 70 is included, the B.NE instruction shown in the sequence of FIG. 5 causes the processing circuitry to read the AFR1 register 70 to determine where execution is to branch to.

The AFR2 register 72 provides hardware support to enable the threadlet execution circuitry 52 to determine when execution of the alternative function has completed. For example, if the AFR2 register 72 stores a pointer to a return address of the function, the threadlet execution circuitry 52 may monitor the instructions executed by the CPU 51 and compare their instruction addresses with that stored in the AFR2 register. When an instruction with an address matching that stored in AFR2, the TE 52 may issue a “done” signal (cessation indication) to indicate, to the CPU 51, that execution of the function has completed. For example, the cessation indication could be a signal asserted by the TE, or it could be a flag set by the TE.

In some examples of the present technique, the cessation indication is set by the TE when it detects that the CPU 51 has completed execution of the alternative function may be identical to a cessation indication used when the TE completes execution of a threadlet. This allows the CPU to respond to completion of execution of the alternative function in the same way as it would have responded to completion of execution of the threadlet. For example, at some later stage, the CPU 51 may execute an XSYNC or XSYNCS instruction as described above.

Note that, while this example shows the TE as being separate from the CPU, the present technique may also be implemented in apparatuses arranged as in FIGS. 1 and 2.

FIG. 7 illustrates another new instruction introduced to support the present technique. This instruction—labelled “XSETAFR”—is the set-AFR instruction, which is used to set up the AFR1 and AFR2 registers described above. The set-AFR instruction shown in FIG. 7 has the following fields:
a field (#imm) indicating the identifier of a TE-note that this field may not be necessary in cases where only one TE is provided in the hardware;
a field identifying a register (x0) holding an address pointer to a routine (e.g. the alternative function) with matching or similar capability to that of a given threadlet—this pointer is to be stored in the AFR1 register of the identified TE upon execution of the set-AFR instruction; and
a field identifying a register (x1) holding an address of a return instruction in that routine—this address is to be stored in the AFR2 register of the identified TE upon execution of the set-AFR instruction.

Decoding circuitry of an apparatus according to the corresponding technique may, therefore, be capable of decoding the set-AFR instruction, and controlling processing circuitry to store the values held in x0 and x1 to the AFR1 and AFR2 registers of the identified TE. Hence, the apparatus of some examples of the present technique provides architectural support for the set-AFR instruction, which facilitates the use of the AFR1 and AFR2 registers.

FIG. 8 is a flow diagram illustrating an example of a method of executing a non-blocking threadlet-start (XSTARTS) instruction. This method may, in some examples, be executed by the processing circuitry described above.

The method includes determining 80 whether the XSTARTS instruction has been encountered and, when the instruction has been encountered, determining 82 whether the threadlet execution circuitry is available and suitable for executing a given threadlet. If it is determined that the threadlet execution circuitry is suitable and available, a start command is sent 84 to the threadlet execution circuitry. On the other hand, if it is determined that the threadlet execution circuitry is unavailable and/or unsuitable, the processing circuitry reads 86 the AFR1 register and determines 88 whether the AFR1 register holds a valid address pointer. For example, this may involve reading a valid bit/field of the AFR1 register and determining whether it is set to a value indicating that the pointer is valid. If it is determined that the AFR1 holds a valid address pointer, the method includes executing 90 a branch with link instruction to branch to an instruction identified by the address pointer in the AFR1 register. On the other hand, if it is determined that the AFR1 register does not hold a valid address pointer, an error response is triggered 92.

FIG. 9 is a flow diagram illustrating a method of monitoring execution of instructions by processing circuitry. This method may, in some examples, be performed by the threadlet execution circuitry described in the above examples.

The method starts with a step 94 of monitoring instructions executed by the processing circuitry and determining 96 whether an instruction at an address corresponding to the address information stored in the AFR2 register has been executed. The monitoring 94 continues until it is determined 96 that such an instruction has been executed, in response to which a “done” signal (or “cessation” signal) is indicated 98 to the processing circuitry.

FIG. 10 is a flow diagram illustrating a method of executing a set-AFR (XSETAFR) instruction. This method may, in some examples, be performed by processing circuitry.

The method includes a step 100 of determining whether the set-AFR instruction has been encountered. When it is determined that the set-AFR instruction has been encountered, a pointer to an alternative function is stored 102 to the AFR1 register, and a valid field is set to indicate that the register stores a valid address pointer. In addition, an address of a return instruction in the alternative routine is stored 104 to the AFR2 register, and a corresponding valid field is set.

FIG. 11 illustrates a simulator implementation that may be used. Whilst the earlier described embodiments implement the present invention in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically, a simulator implementation may run on a host processor 120, optionally running a host operating system 118, supporting the simulator program 112. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. For example, the simulator program 112 shown in FIG. 11 contains processing program logic 114, to emulate the processing circuitry described above, and threadlet execution program logic 116, to emulate the threadlet execution circuitry described above. Similarly, memory hardware, such as a register or cache, may be implemented in a simulated embodiment as a software data structure. In arrangements where one or more of the hardware elements referenced in the previously described embodiments are present on the host hardware (for example, host processor 120), some simulated embodiments may make use of the host hardware, where suitable.

The simulator program 112 may be stored on a computer-readable storage medium (which may be a non-transitory medium), and provides a program interface (instruction execution environment) to the target code 110 (which may include applications, operating systems and a hypervisor) which is the same as the interface of the hardware architecture being modelled by the simulator program 112. Thus, the program instructions of the target code 110, which could include one or more of the XSTART, XSTARTS, XSYNC, XSYNCS, XEVENT and/or XSETAFR instructions described above, may be executed from within the instruction execution environment using the simulator program 112, so that a host computer 120 which does not actually have the hardware features of the apparatus discussed above can emulate these features.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Further, the words “comprising at least one of . . . ” in the present application are used to mean that any one of the following options or any combination of the following options is included. For example, “at least one of: A; B and C” is intended to mean A or B or C or any combination of A, B and C (e.g. A, or B, or C, or A and B, or A and C, or B and C, or A and B and C).

Various methods are described in this application. It will be appreciated that any of these methods can, in some examples, be implemented by a computer executing instructions of a computer program. Such a computer program can be stored on a computer-readable storage medium, such as a transitory medium or a non-transitory medium.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
processing circuitry to execute instructions; and
threadlet execution circuitry to execute tasks under control of the processing circuitry, wherein the threadlet execution circuitry is configured to operate asynchronously with respect to the processing circuitry;
wherein:
the threadlet execution circuitry is responsive to a start command issued by the processing circuitry to begin execution of a threadlet comprising at least one delegated task; and
the processing circuitry is responsive to a threadlet-start instruction, the threadlet-start instruction indicating a request to issue the start command to the threadlet execution circuitry, to determine, in dependence on at least one parameter, whether to trigger execution, by the processing circuitry, of an alternative function instead of issuing the start command to the threadlet execution circuitry.

2. The apparatus of claim 1, wherein:
the processing circuitry is responsive to determining to trigger execution of the alternative function instead of issuing the start command to the threadlet execution circuitry to branch execution to an identified instruction.

3. The apparatus of claim 2, comprising
an alternative-function register (AFR),
wherein the processing circuitry is responsive to determining to trigger execution of the alternative function instead of issuing the start command to the threadlet execution circuitry to branch execution to an instruction identified by an address indicated in the AFR.

4. The apparatus of claim 3, wherein
the AFR comprises one of:
a general-purpose register associated with the processing circuitry; or
a special-purpose register associated with the threadlet execution circuitry.

5. The apparatus of claim 3, wherein
the processing circuitry is responsive to a set-AFR instruction to store, in the AFR, an address pointer specified by the set-AFR instruction.

6. The apparatus of claim 5, wherein
the processing circuitry is responsive to the set-AFR instruction to record a predetermined value in a valid field of the AFR, the predetermined value indicating that the AFR holds an indication of a valid address.

7. The apparatus of any of claim 3, wherein
the processing circuitry is responsive to determining to trigger execution of the alternative function instead of issuing the start command to the threadlet execution circuitry to:
determine whether a valid field of the AFR holds a predetermined value indicating that the AFR holds a valid indication of an address; and
in response to determining an absence of the predetermined value in the valid field of the AFR, initiate an error response.

8. The apparatus of claim 3, wherein
the processing circuitry is configured to determine whether to trigger execution of the alternative function instead of issuing the start command to the threadlet execution circuitry in dependence on, as the at least one parameter, whether the execution, by the threadlet execution circuitry, of a previous threadlet is in progress.

9. The apparatus of claim 8, wherein
the processing circuitry is responsive to determining that execution, by the threadlet execution circuitry, of the previous threadlet is in progress to trigger execution of the alternative function instead of issuing the start command to the threadlet execution circuitry.

10. The apparatus of claim 8, wherein:
the threadlet execution circuitry is configured to set a cessation indication in response to completion of execution of the previous threadlet; and
the processing circuitry is configured to determine whether the threadlet execution circuitry has completed execution of the previous threadlet in dependence on whether the cessation indication has been set.

11. The apparatus of claim 1, wherein
the processing circuitry is configured to determine whether to trigger execution of the alternative function instead of issuing the start command to the threadlet execution circuitry in dependence on, as the at least one parameter, one or more power and/or thermal requirements.

12. The apparatus of claim 1, wherein
the processing circuitry is configured to determine whether to trigger execution of the alternative function instead of issuing the start command to the threadlet execution circuitry in dependence on, as the at least one parameter, whether the at least one delegated task is supported by the threadlet execution circuitry.

13. The apparatus of claim 1, wherein
the processing circuitry is configured to determine whether to trigger execution of the alternative function instead of issuing the start command to the threadlet execution circuitry in dependence on, as the at least one parameter, a determination of whether a granularity of the threadlet satisfies a threshold granularity defined for the threadlet execution circuitry.

14. The apparatus of claim 1, wherein
the threadlet execution circuitry is responsive to completion of execution of the alternative function to set a cessation indication.

15. The apparatus of claim 14, comprising
an alternative-function-return register to hold an indication of a return instruction address, wherein:
the threadlet execution circuitry is configured to monitor execution of instructions by the processing circuitry and determine, based on the return instruction address, whether the processing circuitry has executed a corresponding return instruction; and
the threadlet execution circuitry is responsive to determining that the processing circuitry has executed the corresponding return instruction to set the cessation indication.

16. The apparatus of claim 15, comprising
an alternative-function register (AFR),
wherein:
the processing circuitry is responsive to determining to trigger execution of the alternative function instead of issuing the start command to the threadlet execution circuitry to branch execution to an instruction identified by an address indicated in the AFR; and
the processing circuitry is responsive to a set-AFR instruction to:
store, in the AFR, an address pointer specified by the set-AFR instruction; and
store, in the alternative-function-return register, a return instruction address pointer specified by the set-AFR instruction.

17. A computer program comprising computer-readable code for fabrication of the apparatus of claim 1.

18. A method for controlling threadlet execution circuitry to perform tasks, the method comprising:
controlling, using processing circuitry, threadlet execution circuitry to execute tasks, wherein the threadlet execution circuitry is configured to operate asynchronously with respect to the processing circuitry;
issuing, using the processing circuitry, a start command to the threadlet execution circuitry to cause the threadlet execution circuitry to begin execution of a threadlet comprising at least one delegated task; and
in response to a threadlet-start instruction, the threadlet-start instruction indicating a request to issue the start command to the threadlet execution circuitry, using the processing circuitry to determine, in dependence on at least one parameter, whether to trigger execution, by 10 the processing circuitry, of an alternative function instead of issuing the start command to the threadlet execution circuitry.

19. A computer program comprising instructions which, when executed by a host data processing apparatus, control the host data processing apparatus to provide an instruction execution environment for executing target program code, the computer program comprising:
processing program logic to execute instructions; and
threadlet execution program logic execute tasks under control of the processing program logic, wherein the threadlet execution program logic is configured to operate asynchronously with respect to the processing program logic;
wherein:
the threadlet execution program logic is responsive to a start command issued by the processing program logic to begin execution of a threadlet comprising at least one delegated task; and
the processing program logic is responsive to a threadlet-start instruction, the threadlet-start instruction indicating a request to issue the start command to the threadlet execution program logic, to determine, in dependence on at least one parameter, whether to trigger execution, by the processing program logic, of an alternative function instead of issuing the start command to the threadlet execution program logic.
